(19) United States
(12) Patent Application Publication
(10) Pub. No.: US 2025/0355680 A1
(43) Pub. Date: Nov. 20, 2025

(54) SESSION INFORMATION PROCESSING METHOD AND APPARATUS, AND ELECTRONIC DEVICE

(71) Applicant: Beijing Zitiao Network Technology Co., Ltd., Beijing (CN)

(72) Inventors: Junxiao HU, Beijing (CN); Yongqiang ZHAO, Beijing (CN); Bowen SHEN, Beijing (CN); Lingfei WANG, Beijing (CN)

(21) Appl. No.: 18/868,730

(22) PCT Filed: May 24, 2023
(86) PCT No.: PCT/CN2023/095940

§ 371 Date: Nov. 22, 2024

(30) Foreign Application Priority Data
May 30, 2022 (CN) 202210611949.X
Sep. 14, 2022 (CN) 202211117880.1

(51) Int. Cl. G06F 9/451

(52) U.S. Cl. CPC G06F 9/451

(57) ABSTRACT

Disclosed in embodiments of the present invention are a session information processing method and apparatus, and an electronic device. The method comprises: displaying a first window in a client interface, the first window being used for displaying an information stream; and in response to reception of a grouping information display instruction, in addition to displaying the first window, displaying a second window in the client interface, the second window being used for displaying grouping information, the grouping information comprising information of a plurality of groups, each group corresponding to an information stream screened out by using a preset screening condition of the group, and the information stream comprising one or two of a session and a message. The grouping information for managing the information stream can be displayed according to user requirements. On one hand, the user can conveniently group and browse the information stream, and on the other hand, when the grouping information does not need to be browsed, the second window is not displayed, and the information stream is displayed in the first window in a manner that a user is accustomed to.

### CROSS-REFERENCE TO RELATED APPLICATIONS

This application is a U.S. National Stage under 35 U.S.C. § 371 of International Application No. PCT/CN2023/095940, as filed on May 24, 2023, which is based on and claims priority to the Chinese Patent Application No. 202210611949.X entitled “SESSION INFORMATION PROCESSING METHOD AND APPARATUS, AND ELECTRONIC DEVICE” and filed on May 30, 2022, and the Chinese Patent Application No. 202211117880.1 entitled “SESSION INFORMATION PROCESSING METHOD AND APPARATUS, AND ELECTRONIC DEVICE” and filed on Sep. 14, 2022, and the disclosures of each of these applications are incorporated by reference herein in their entireties.

### TECHNICAL FIELD

The present disclosure relates to field of computer technology and software technology, and particularly to a session information processing method and apparatus, and an electronic device.

### BACKGROUND

With the development of computer and internet technologies, users can perform information interaction, process online documents, and the like through applications provided in an electronic terminal.

The users may perform information interaction with multiple contacts through a session application. A client interface of the application may display information of sessions with the multiple contacts.

### SUMMARY

This SUMMARY is provided to introduce concepts in a simplified form that are described in detail in the following DETAILED DESCRIPTION. This SUMMARY is not intended to identify key features or essential features of the claimed technical solutions, nor is it intended to be used to limit the scope of the claimed technical solutions.

Embodiments of the present disclosure provide a session information processing method and apparatus, and an electronic device.

In a first aspect, an embodiment of the present disclosure provides a session information processing method, comprising: displaying a first window in a client interface, the first window being used for displaying an information stream; and in response to receiving a group information display instruction, in addition to displaying the first window, displaying a second window in the client interface, the second window being used for displaying group information, the group information comprising information of a plurality of groups, each group corresponding to an information stream screened out by using a preset screening condition of the group, the information stream comprising one or both of a session and a message.

In a second aspect, an embodiment of the present disclosure provides a session information processing method, comprising: displaying a first window, a second window and a third window in a client interface; wherein, the first window is used for displaying an information stream, and the information stream comprises one or both of a session and a message; the third window is used for displaying an interactive interface corresponding to a currently selected session or message in the first window; the second window is used for displaying group information, the group information comprises information of a plurality of groups, and each group corresponds to an information stream screened out by using a preset screening condition of the group; and in response to an operation of a user selecting a group in the second window, displaying an information stream corresponding to the selected group in the first window.

In a third aspect, an embodiment of the present disclosure provides a session information processing apparatus, comprising: a first display unit, configured to display a first window in a client interface, the first window being used for displaying a session stream; and a second display unit, configured to, in response to receiving a group information display instruction, in addition to displaying the first window, display a second window in the client interface, the second window being used for displaying group information, the group information comprising information of a plurality of groups, each group corresponding to an information stream screened out by using a preset screening condition of the group, the information stream comprising one or both of a session and a message.

In a fourth aspect, an embodiment of the present disclosure provides a session information processing apparatus, comprising: a third display unit, configured to display a first window, a second window and a third window in a client interface; wherein, the first window is used for displaying an information stream, and the information stream comprises one or both of a session and a message; the third window is used for displaying an interactive interface corresponding to a currently selected session or message in the first window; the second window is used for displaying group information, the group information comprises information of a plurality of groups, and each group corresponds to an information stream screened out by using a preset screening condition of the group; and a fourth display unit, configured to, in response to an operation of a user selecting a group in the second window, display a session stream or information stream corresponding to the selected group in the first window.

In a fifth aspect, an embodiment of the present disclosure provides an electronic device, comprising: one or more processors; and storage means configured to store one or more programs, which when executed by the one or more processors, cause the one or more processors to implement the session information processing method according to the first aspect or the second aspect.

IN A SIXTH ASPECT, AN EMBODIMENT OF THE PRESENT DISCLOSURE PROVIDES A COMPUTER READABLE MEDIUM HAVING THEREON STORED A COMPUTER PROGRAM, WHICH WHEN EXECUTED BY A PROCESSOR, IMPLEMENTS THE STEPS OF THE SESSION INFORMATION PROCESSING METHOD ACCORDING TO THE FIRST ASPECT OR THE SECOND ASPECT.

### BRIEF DESCRIPTION OF THE DRAWINGS

The above and other features, advantages, and aspects of the embodiments of the present disclosure will become more apparent by referring to the following DETAILED DESCRIPTION when taken in conjunction with the accompanying drawings. Throughout the drawings, the same or similar reference numbers refer to the same or similar elements. It should be understood that the drawings are schematic and that elements and components are not necessarily drawn to scale.

FIG. 1 is a flowchart of one embodiment of the session information processing method according to the present disclosure;

FIG. 2A is a schematic diagram of an application scenario of the session information processing method of the present disclosure;

FIGS. 2B-2C are schematic diagrams of an application scenario of the session information processing method of the present disclosure;

FIGS. 2D-2E are schematic diagrams of an application scenario of the session information processing method of the present disclosure;

FIGS. 2F-2G are schematic diagrams of still another application scenario of the session information processing method of the present disclosure;

FIG. 3 is a flowchart of yet another embodiment of the session information processing method according to the present disclosure;

FIG. 4A is a schematic diagram of an application scenario of the session information processing method according to the present disclosure;

FIGS. 4B-4E are schematic diagrams of another application scenario of the session information processing method of the present disclosure;

FIG. 5 is a flowchart of yet another embodiment of the session information processing method according to the present disclosure;

FIGS. 6A-6B are schematic diagrams of an application scenario of the session information processing method of the present disclosure;

FIG. 7 is a schematic block diagram of one embodiment of the session information processing apparatus according to the present disclosure;

FIG. 8 is a schematic block diagram of one embodiment of the session information processing apparatus according to the present disclosure;

FIG. 9 is an exemplary system architecture to which the session information processing method of one embodiment of the present disclosure may be applied;

FIG. 10 is a schematic diagram of a basic structure of an electronic device provided according to an embodiment of the present disclosure.

### DETAILED DESCRIPTION

The embodiments of the present disclosure will be described in more detail below with reference to the accompanying drawings. While certain embodiments of the present disclosure are shown in the drawings, it should be understood that the present disclosure may be implemented in various forms and should not be construed as limited to the embodiments set forth herein, but rather, these embodiments are provided for a more complete and thorough understanding of the present disclosure. It should be understood that the drawings and the embodiments of the present disclosure are for exemplary purposes only and are not intended to limit the protection scope of the present disclosure.

It should be understood that various steps recited in method embodiments of the present disclosure may be performed in a different order, and/or performed in parallel. Moreover, the method embodiments may comprise additional steps and/or omit performing the illustrated steps. The scope of the present disclosure is not limited in this respect.

The term “comprising” and variations thereof used herein are intended to be open-ended, i.e., “comprising but not limited to”. The term “based on” is “at least partially based on”. The term “one embodiment” means “at least one embodiment”; the term “another embodiment” means “at least one other embodiment”; the term “some embodiments” means “at least some embodiments”. Relevant definitions for other terms will be given in the following description.

It should be noted that the concepts “first”, “second”, and the like mentioned in the present disclosure are only used for distinguishing different devices, modules or units, and are not used for limiting the order or interdependence of functions performed by the devices, modules or units.

It should be noted that modifications of “one”, “plurality” mentioned in this disclosure are intended to be illustrative rather than restrictive, and that those skilled in the art should appreciate that they should be understood as “one or more” unless otherwise explicitly stated in the context.

Names of messages or information exchanged between a plurality of devices in the embodiments of the present disclosure are for illustrative purposes only, and are not intended to limit the scope of the messages or information.

People can use an instant messaging application during work, facilitating communication between users and other users. While enjoying the convenient communication brought by office instant messaging applications, people are also bearing the pressure brought by a large amount of messages. Due to the fact that the number of messages is large and the messages are sent frequently, a user cannot find a time period for concentrating on design and document processing. Furthermore, some users fear having to process a large number of messages after attending a meeting and have to be distracted from processing information in the meeting. Although there is a “message do-not-disturb” capability, many users dare not to set it because of fear that information will be dropped later after the do-not-disturb setting, or after the do-not-disturb setting, they are still disturbed by full-screen do-not-disturb sessions. This is not a truly efficient working mode.

Therefore, it is desirable that, an instant messaging application as an instant messaging tool in work, can give more management and control capabilities to users in depth, allowing users to group sessions. By grouping sessions to sort session priorities, and managing multiple sessions in different manners, even if a push is not received, a session can also be conveniently found when needed.

In addition, the grouping of the sessions or messages is for conveniently managing the sessions or messages by the user. The user does not need to see the group information all the time.

According to the session information processing method and apparatus, and the electronic device provided by the embodiments of the present application, by displaying a first window in a client interface, the first window being used for displaying a session stream; and in response to receiving a group information display instruction, in addition to displaying the first window, displaying a second window in the client interface, the second window being used for displaying group information, the group information comprising information of a plurality of groups, each group corresponding to an information stream screened out by using a preset screening condition of the group, the information stream comprising one or both of a session and a message, the group information for managing the screened grouping of the information stream can be displayed according to user requirements. On one hand, the user can conveniently group and browse the information stream, and on the other hand, when it is not needed to browse the group information, the second window is not displayed, and the information stream is displayed in the first window in a user-accustomed way.

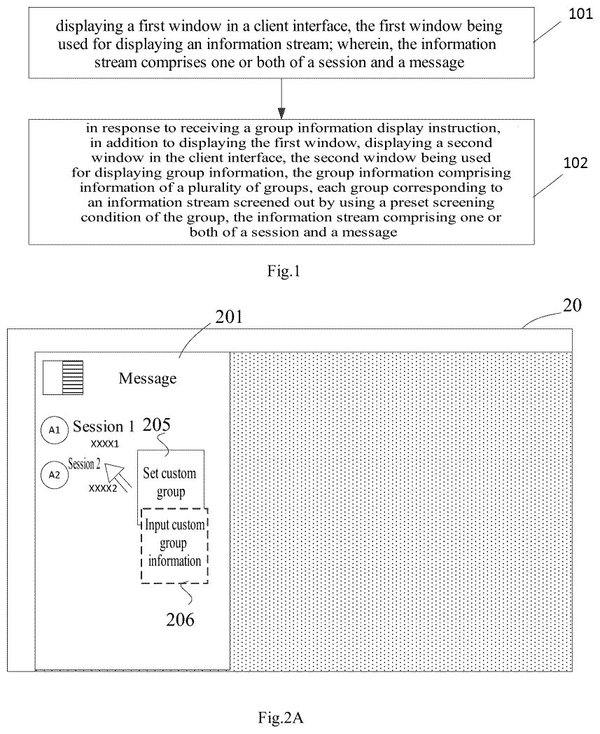

Referring to FIG. 1, a flowchart of one embodiment of the session information processing method according to the present disclosure is shown. As shown in FIG. 1, the session information processing method comprises the following steps:
step 101, displaying a first window in a client interface, the first window being used for displaying an information stream, wherein, the information stream comprises one or both of a session and a message.

The client interface is an interface of a preset application client, and the preset application client can be a client of any application with an instant messaging function. Through the preset application client, a user can perform information interaction with other users. For example, the client may be a client of an instant messaging application, or may be a client of an office suite application including an instant messaging application. Generally, the office suite application is integrated with multiple office applications such as an instant messaging application, a document application, and an audio/video conference application.

An execution subject of the session information processing method may be an electronic device running the preset application client, such as a desktop computer, a portable computer, a mobile terminal, and the like.

The information stream may include at least one session and/or at least one message. The at least one session may include a group chat session, a single chat session, and the like. The at least one message may include, for example, a message sent by a robot in an instant messaging application. The messages sent by the robot include welcome cards, operation prompts, notifications and the like. In addition, the at least one message may further include a directional message sent in an online document in the preset application client to a user logging in the preset application client, for example, when a certain user is @ in the document, the user may receive a notification message.

A height of the first window may be approximately equal to a height of the client interface.

Step 102, in response to receiving a group information display instruction, in addition to displaying the first window, displaying a second window in the client interface, the second window being used for displaying group information, the group information comprising information of a plurality of groups, each group corresponding to an information stream screened out by using a preset screening condition of the group, and the information stream comprising one or both of a session and a message.

The user can send an information display instruction to the execution subject of the session information processing method. The execution subject, after receiving the group information display instruction, can also display a second window in the client interface. That is, the first window and the second window are displayed simultaneously. A height of the second window is equal to the height of the first window. There is no overlap between the first window and the second window.

In some alternative implementations, the group information display instruction is generated based on one of: a user issuing a preset operation; the preset operation being used for instructing displaying the second window; a message to be processed of at least one group meeting a first preset condition; or the user performing an operation of setting sub-groups on one group.

In some application scenarios, the group information display instruction is generated based on a preset operation issued by a user.

In particular, a first switching control can be displayed in the first window. The preset trigger operation comprises an operation performed on the first switching control displayed in the first window. The operation here may be a click operation or a touch operation. That is, the user performs a trigger operation on the first switching control displayed in the first window, so as to cause the second window to be displayed.

In some other application scenarios, the group information display instruction is generated based on a message to be processed of at least one group meeting a first preset condition. The first preset condition here may include one of: the number of messages to be processed being greater than or equal to a preset number threshold; the message to be processed being an urgent message.

The preset number threshold may be, for example, 10, 20. The preset number threshold may be set according to a specific application scenario, and is not limited herein.

In these application scenarios, when the number of the messages to be processed corresponding to at least one group is greater than or equal to the preset number threshold or the message to be processed is an urgent message, the group information display instruction may be issued to the execution subject of the session information processing method.

In other application scenarios, the group information display instruction is generated based on an operation that the user sets a target session as a custom group through an identification of the target session.

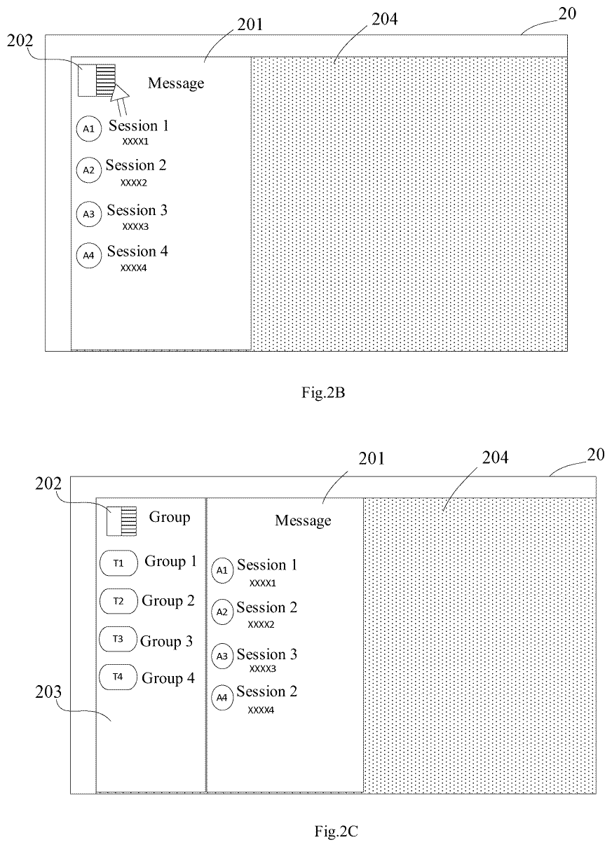

As shown in FIG. 2A, a first window 201 is displayed on a client interface 20, and an information stream is displayed in the first window 201. The information stream includes session 1 and session 2. The message of the session 1 displayed in the first window 201 may include the most recent message “XXXX1”. The messages of the session 2 may include the most recent message “XXXX2”. The user may perform a trigger operation (e.g., right click) on the session 2 displayed in the first window, thereby displaying an edit window 205 for the session 2. The edit window comprises an edit item “set custom group” for setting a custom group corresponding to the session. After the user performs a trigger operation on the edit item of the custom group, an information entry window 206 for entering custom group information may be displayed. The user may enter a name of the custom group, a graphical identifier, etc. in the information entry window 206. The session 2 is grouped into the entered custom group through the operation. And detecting that the session 2 is successfully grouped into the entered custom group, the group information display instruction is generated. This facilitates the user to browse the user-entered custom group information in the displayed second window.

In these alternative implementations, the display of the second window may be triggered in a variety of ways.

The group information may be displayed in the second window. The group information herein includes identifiers of a plurality of groups, such as text identifiers and/or graphical identifiers, etc.

The session information processing method provided by the embodiment, by first displaying the first window for displaying the information stream in the preset application client interface, and then in response to receiving the group information display instruction, displaying both the first window and the second window for displaying the group information in the preset application client interface, the group information for managing the information stream can be displayed according to the user requirements. On one hand, the user can conveniently group and browse the information stream, and on the other hand, when it is not needed to browse the group information, the second window is not displayed, and the information stream is displayed in the first window in a user-accustomed way.

In some alternative implementations, the client further displays a third window, the third window being used for display an interactive interface corresponding to a currently selected session or message in the first window; wherein there is no overlap between the first window, the second window, and the third window; the second window, the first window and the third window are sequentially arranged in a first direction.

The second window, the first window and the third window are sequentially arranged from left to right or from right to left in a transverse direction of the client interface.

Namely, the second window, the first window and the third window are sequentially arranged in three columns from left to right.

The second window, the first window and the third window can also be arranged in three columns from right to left.

The third window is used for displaying an interactive interface corresponding to the currently selected session or message in the first window. For example, the interactive interface corresponding to the session is a session interface of a single chat or a group chat; when the message is a document notification message, the interactive interface corresponding to the message is a corresponding document interface, and when the message is a notification interface of a robot assistant, the interactive interface corresponding to the message is a session interface with the corresponding robot assistant.

In some application scenarios, a first switching control may be displayed in the first window while a second window is not displayed. The first switching control is used for controlling the display state of the second window. When the user triggers the first switching control, the first window and the second window can be simultaneously displayed in the preset application client interface.

When the second window is displayed, the first switching control may be displayed in the second window. The display of the first switching control is cancelled in the first window. The second window here can be displayed in response to the user performing a trigger operation on the first switching control displayed in the first window; the second window may also be displayed because the message to be processed meets a first preset condition; and also can be displayed because the user performs an operation of setting a target session into a custom group through the identification of the target session. If the user wants to hide the second window, the first toggle control displayed in the second window may be triggered.

Please refer to FIGS. 2B to 2C, which are schematic diagrams of some application scenarios of the session information processing method provided by the present disclosure. As shown in FIG. 2B, a first window 201 is displayed on a preset application client interface 20. An information stream is displayed in the first window 201. The information stream include session 1, session 2, session 3, and session 4. The message of the session 1 displayed in the first window 201 may include the most recent message “XXXX1”. The message of the session 2 may include the most recent message “XXXX2”. The messages of the session 3 may include the most recent message “XXXX3”. The message of the session 4 may include the most recent message “XXXX4”. A first switching control 202 may be displayed in the first window 201. The user can perform a trigger operation on the first switching control 202. Upon receiving the trigger operation on the first switching control 202, a second window 203 may be displayed in the client interface 20, as shown in FIG. 2C. After the second window 203 is displayed in the preset application client interface 20, the first switching control 202 may be displayed in the second window 203, and the displaying the first switching control is cancelled in the first window 201. The user may also cancel displaying the second window 203 in the interface 20 of the preset application client by performing a trigger operation on the first switching control 202 displayed in the second window 203, and the interface after canceling displaying the second window 203 is shown in FIG. 2B. A third window 204 in FIGS. 2B and 2C is an interactive interface corresponding to the selected session or message in the first window 201.

In the related art, the group information is displayed in the first window 201, for example, the group information is displayed above the information stream of the first window. And the plurality of group information can be displayed in a single line in the first window. Information of groups that cannot be arranged in a single row of the first window is folded. Such a group information display mode is limited by a width of the first window, and information of a plurality of groups cannot be displayed in the first window relatively comprehensively. In addition, if too much group information is displayed in the first window, the display area for the information stream will be reduced, affecting the display effect of the information stream.

In these alternative implementations, in a state where the second window is displayed, the second window displaying the group information, the first window displaying the information stream, and the third window displaying the interactive interface of the selected session or message are sequentially arranged in the first direction. Since the second window is the same height as the first window, the second window can accommodate more complete group information. Therefore, the user can see more complete group information, improving the group information presentation efficiency. In addition, the first window and the third window are arranged adjacent to each other, meeting the browsing habit of the user.

In some alternative implementations, the session information processing method further comprises: in response to receiving a group information hiding instruction, canceling displaying the second window, and adaptively adjusting a display position and size of the first window.

That is to say, when the first window and the second window are displayed in the client interface, when an instruction of hiding the second window displaying the group information is received, displaying the second window is cancelled, and the first window is adaptively adjusted in the client interface, so that the first window is more reasonably displayed in the preset client interface.

In these alternative implementations, by switching the display size and display position of the first window in the displayed or hidden state of the second window, the window display is adapted.

In still other application scenarios, the second window may also be in a floating window form, rather than a window form juxtaposed to the first and third windows. In the application scenario, the first window and the third window can be regarded as two columns of windows, and the second window is a floating window suspended on the first window and/or the third window.

In some alternative implementations, the first window and the third window are not overlapped and are sequentially arranged in the first direction; the second window is displayed on the first window and/or the third window in a floating window form.

When the second window is displayed on the first window or the third window in the floating window form, a window size of the second window is smaller than or equal to the size of the first window, or the window size of the second window is smaller than or equal to the size of the third window.

When the second window is displayed in the floating window form on the first window and the third window, the second window is equivalent to a partial window occupying the first window, and a partial window occupying the third window.

Correspondingly, the group information display instruction can be generated based on an operation on the first switching control. Thus, in some alternative implementations, the in response to receiving a group information display instruction, in addition to displaying the first window, displaying a second window in the client interface, comprises: in response to an operation of hovering a mouse or cursor over a first switching control displayed in the first window, displaying the second window in a floating window form.

Based on this alternative implementation, when the user does not need to display the second window, the operation of hovering the mouse or cursor over the first switching control may be initiated again, to generate a second window closing instruction. Alternatively, the user may click on a location other than the second window to generate the second window closing instruction.

Thus, in some alternative implementations, the method further comprises: in response to the second window closing instruction, canceling displaying the second window. The second window closing instruction is generated based on a re-trigger operation on the first switching control; or the second window closing instruction is generated based on a click operation on a location other than the second window.

Please refer to FIGS. 2D to 2E in combination, which are schematic diagrams of some application scenarios of the session information processing method provided by the present disclosure. As shown in FIG. 2D, the first window 201 is displayed on the preset application client interface 20. The information stream is displayed in the first window 201. The information stream includes session 1, session 2, session 3, and session 4. The message of the session 1 displayed in the first window 201 may include the most recent message “XXXX1”. The message of the session 2 may include the most recent message “XXXX2”. The message of the session 3 may include the most recent message “XXXX3”. The message of the session 4 may include the most recent message “XXXX4”. The first switching control 202 may be displayed in the first window 201. The user can perform a trigger operation on the first switching control 202. Upon receiving the trigger operation on the first switching control 202, the second window 203 may be displayed in the client interface 20, as shown in FIG. 2E. After the second window 203 is displayed in the preset application client interface 20, the user may also cancel displaying the second window 203 in the preset application client interface 20 by performing a trigger operation on the first switching control 202 displayed in the first window 201, and an interface after canceling displaying the second window 203 is shown in FIG. 2D. That is, after displaying the second window 203 is cancelled, the display interface shown in FIG. 2D is restored on the client interface 20. The third window 204 in FIGS. 2D and 2E is an interactive interface corresponding to the selected session or message in the first window 201.

In some application scenarios, when a user views an information stream corresponding to a group, a need to switch information streams corresponding to other groups may arise.

Thus, in some alternative implementations, the method further comprises: in response to an operation of selecting a first group in the second window, displaying an information stream corresponding to the first group in the first window; and in response to an information stream closing instruction, canceling displaying the information stream corresponding to the first group.

The information stream corresponding to the first group may be an information stream screened out by using a screening condition corresponding to the first group.

In some alternative implementations, after canceling displaying the information stream corresponding to the first group, the method further comprises: displaying an information stream corresponding to a preset default group in the first window.

The preset default group may be a system-defined group, such as: message or all, etc. It may also be a user-defined group, for example, the system provides a user-defined setting entry, a user can perform self-defined setting when entering the self-defined setting entry, and the system saves the self-defined setting of the user.

In some implementations, an exit control is also displayed in the first window, and the information stream closing instruction is generated based on a trigger operation on the exit control.

In other implementations, the information stream closing instruction may also be generated based on an exit control displayed in the third window.

In still other implementations, the information stream closing instruction may also be generated based on a preset trigger condition. For example: when the user does not operate the information stream corresponding to the first group for a long time, the user may have a need to close the information stream. Therefore, when the information stream corresponding to the first group does not receive a corresponding operation within a preset duration, the information stream closing instruction is generated. Wherein, the preset duration may be 1 minute, 5 minutes, etc.

Please refer to FIGS. 2F to 2G in combination, which are schematic diagrams of some application scenarios of the session information processing method provided by the present disclosure. As shown in FIG. 2F, the information stream corresponding to group 1 is displayed in the first window 201, including: session 1 to session 4. And, an exit control 205 is also displayed in the first window 201, and a user can perform a trigger operation on the exit control 205 to initiate an information stream closing instruction. After the user performs a trigger operation on the exit control 205, displaying the information stream corresponding to the display group 1 is cancelled, and the information stream corresponding to the preset default group is displayed in the first window 201. The display interface of the information stream corresponding to the preset default group is shown in FIG. 2G, where the default group is denoted as group X, and the corresponding information stream includes session 5 to session 7. In FIGS. 2F and 2G, the third window 204 is an interactive interface corresponding to the session or message selected in the first window 201.

In some embodiments, when the information stream corresponding to the preset default group is displayed in the first window 201, the exit control 205 may be displayed as shown in FIG. 2G, and after the exit control 205 is clicked, the information stream is not displayed in the first window 201. In other embodiments, when the information stream corresponding to the preset default group is displayed in the first window 201, the exit control 205 is no longer displayed, so that an information stream is always displayed in the first window 201.

In some application scenarios, the user may desire to display the first window, the second window, and the third window in three columns; whereas, in other application scenarios, the user may desire to display the second window in a floating window, and display the first window and the third window in columns.

Therefore, in some application scenarios, it is possible for the client to display prompt information when the user initiates the group information display instruction, and then select which display mode to use based on an operation of the user on the prompt information.

Certainly, in other application scenarios, for the client, the floating window display mode of the second window may be a new function of the system after product update. In this case, when the user initiates the group information display instruction, prompt information is displayed, and after the user confirms the prompt information, the second window is displayed in the form of a floating window.

In other words, a corresponding push condition may be set for the prompt information, and when the corresponding push condition is satisfied, the prompt information is displayed. The form of the prompt message may be a floating window form, a dialog box form, etc.

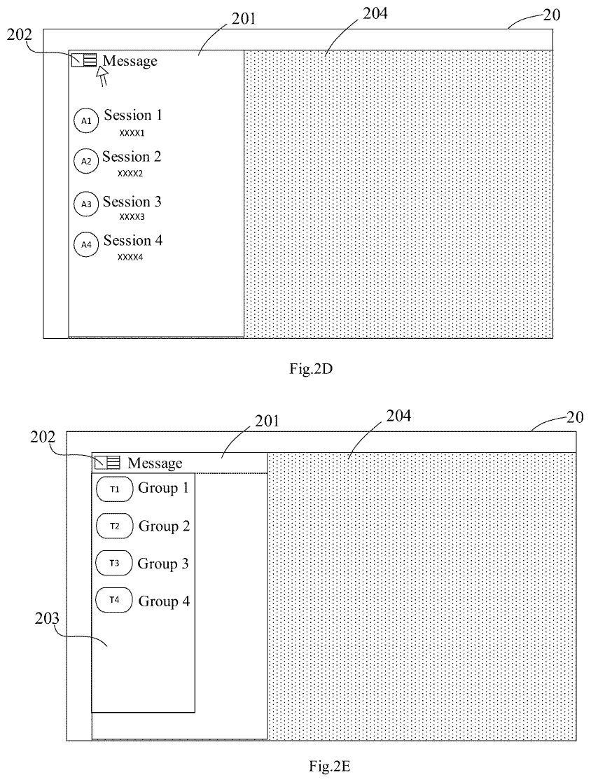

Referring to FIG. 3, a flowchart of some embodiments of the session information processing method provided by the present disclosure is shown. As shown in FIG. 3, the session information processing method comprises the following steps:
step 301, displaying a first window, a second window and a third window on a client; wherein, the first window is used for displaying an information stream, and the information stream comprises one or both of a session and a message; the third window is used for displaying an interactive interface corresponding to currently selected session or message in the first window; the second window is used for displaying group information, the group information comprises information of a plurality of groups, and each group corresponds to an information stream screened out by using a preset screening condition of the group.

In this embodiment, the first window, the second window and the third window may be displayed on a client interface of a preset application. The first window displays the information stream, and the third window displays an interactive interface of the currently selected session and/or message in the first window. The second window displays group information for grouping management of the session and the message.

In some application scenarios, the second window, the first window, and the third window are sequentially arranged in a first direction. The second window, the first window and the third window are not overlapped with each other.

Further, the second window, the first window, and the third window sequentially arranged in a first direction, comprises: sequentially arranged from left to right, or sequentially arranged from right to left in a transverse direction of the client interface.

The second window, the fact that the first window and the third window are sequentially arranged in the first direction, is helpful for setting the three windows at the same height.

In other application scenarios, the first window and the third window are not overlapped and are sequentially arranged in the first direction; the second window is displayed on the first window and/or the third window in a floating window form.

In an embodiment of the present disclosure, the preset application is an application with an instant messaging function. For example, the application may be an instant messaging application, or may be an office suite application including an instant messaging application. Generally, the office suite application is integrated with multiple office applications such as an instant messaging application, a document application, and an audio/video conference application.

The group information in the second window comprises text identifiers and/or graphical identifiers corresponding to the plurality of groups respectively.

Each group corresponds to a preset screening condition. The preset screening condition of the group is used for screening the session and/or message in the information stream. The group may correspond to an information stream consisting of sessions and/or messages screened out by the preset screening condition corresponding to the group.

Step 302, in response to an operation of a user selecting a group in the second window, displaying an information stream corresponding to the selected group in the first window.

When a user selects in the second window one group identifier in the group information, an information stream corresponding to the group identifier may be displayed in the first window.

In some application scenarios, the second window, the first window, and the third window are sequentially arranged from left to right, or sequentially arranged from right to left in the client interface.

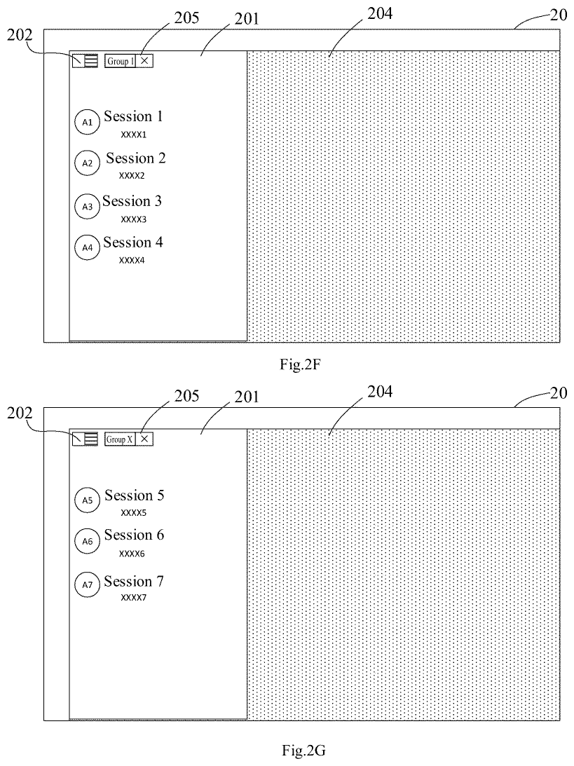

Referring to FIG. 4A, a block diagram of a client interface is shown. As shown in FIG. 4A, a second window 401, a first window 402 and a third window 403 are displayed in a client interface 40. In the above interface, the second window 401, the first window 402 and the third window 403 are sequentially arranged in the client interface from left to right in a transverse direction. Identifiers of group 1, group 2, group 3 and group 4 are displayed in the second window 401, and include graphical identifiers 41, 42, 43, 44 and text identifiers. The text identifiers of the group 1, group 2, group 3, and group 4 are: “group 1”, “group 2”, “group 3”, and “group 4”, respectively. The information stream of the currently selected group 1 is displayed in the first window 402. An identifier “group 1 message” indicating that the information stream is an information stream of group 1 may be displayed in the first window 402. The information streams in the first window 402 include session 1, session 2, session 3, and session 4. The messages for the session 1 displayed in the first window 402 may include the most recent message “XXXX1”.

The message of the session 2 may include the most recent message “XXXX2”. The message of the session 3 may include the most recent message “XXXX3”. The message of the session 4 may include the most recent message “XXXX4”. The currently selected session in the first window 402 is “session 2”, and what is displayed in the third window 403 is an information interactive interface of the session 2. The message “YYYYYY1” sent by the user 1 and the message “YYYYYY2” sent by the user 2 may be displayed in the information interactive interface of the session 2, and the user may also enter a new message through the information interactive interface.

In the related art, the group information is displayed in the first window for displaying the information stream, for example, the group information is displayed above the information stream in the first window. And, a plurality of group information can be only displayed in a single line in the first window. The information of the group which cannot be arranged in a single row of the first window is folded, and such a group information display mode is limited by the width of the first window, so that the information of a plurality of groups cannot be comprehensively displayed in the first window. When the user wants to view the folded group information, it is needed to perform a trigger operation on a folding identifier in the group information display area, to display the folded group information in a new window, affecting the presentation efficiency of the group information. In addition, if too much group information is displayed in the first window, the display area of the information stream will be reduced, affecting the display effect of the information stream.

In the session information processing method provided in this embodiment, by first displaying the first window, the second window, and the third window on the preset application client, and then according to a group selected by the user in the second window, displaying an information stream corresponding to the group in the first window, group information for managing the information stream is displayed in an independent window, so that more complete group information can be displayed in the second window, improving the group information presentation efficiency. In addition, the user is further facilitated to rapidly select, from the group information, a group to browse its information, improving the efficiency of the user managing the information stream.

In some alternative implementations, the session information processing method further comprises: in response to receiving a hiding instruction for hiding the second window, canceling displaying the second window in the client interface.

In particular, a first switching control may be displayed in the second window. The first switching control is used for controlling a display state of the second window. The user can perform a trigger operation on the first switching control, so as to issue the hiding instruction. That is, the second window may be hidden and displayed according to the user's selection. In these alternative implementations, by hiding the second window, the preset application client may display the first window and the third window; on one hand, the preset application client may display the information stream and the interactive interface of the selected session or message in the larger first window and the larger third window.

Further optionally, in a state where the second window is hidden, the first window, the second window, and the third window are displayed in the client interface according to a received display instruction for instructing displaying the second window.

The first switching control may be displayed in the first window while the second window is in the hidden state. When the user needs to browse the group information, the display of the second window can be triggered by performing a trigger operation on the first switching control displayed in the first window.

In this way, the user can conveniently select to display the second window or hide the second window according to his requirement. When the user needs to browse the group information, or screen and consume the information stream through the group information, displaying the second window can be triggered through the first switching control displayed in the first window, and the group information can be displayed in the second window. When the user does not need to browse the group information, hiding the second window can be triggered by triggering the first switching control displayed in the second window.

In some alternative implementations, the method further comprises: in response to an information stream closing instruction, canceling displaying an information stream corresponding to the currently displayed group in the first window. The method further comprising: displaying an information stream corresponding to a preset default group in the first window.

An exit control is also displayed in the first window, and the information stream closing instruction is generated based on a trigger operation on the exit control.

In some alternative implementations, a group edit control is displayed in the second window, and the group edit control is used for displaying a group editing interface according to a received user selection operation, for the user to perform a group editing operation.

Specifically, the group edit control is displayed on the top of the second window, so that on one hand, the group edit control will not affect the display of each group identifier, and on the other hand, when the user needs to edit the group information, the group edit control can be quickly found in the second window.

Group editing operations herein include, but are not limited to, one or more of: adding a group identifier, deleting a group identifier, modifying a group identifier, a display/hiding switching operation of group information, a group identifier display position setting operation, and the like.

By displaying the grouping edit control in the second window, the user can edit the group information more conveniently.

The group information displayed in the second window includes an identifier of the group. The identifier of the group includes a text identifier and/or a graphical identifier.

If a group currently has corresponding messages to be processed, information on the number of the messages to be processed of the group can be displayed in the second window.

In some alternative implementations, if there are messages to be processed within a group, the identifier of the group and/or the information on the number of messages to be processed is highlighted.

The highlighting the identifier of the group comprises that: a display style of the group is different from that of other groups. For example, a font of the group is different from that of other groups; or alternatively, a text label of the group is displayed in bold, or a background color of the identifier of the group is different from that of other groups, or a color of the text identifier of the group is different from that of other groups. Similarly, a display style of the information on the number of messages to be processed corresponding to the group may refer to the display style of the identifier of the group.

In these alternative implementations, by highlighting the group identifier of the group having messages to be processed and/or the information on the number of messages to be processed, the user can quickly find a group having messages to be processed from the information of the plurality of groups, so that the user can process the messages to be processed of the group.

In some alternative implementations, if a group includes at least one sub-group, information of the at least one sub-group of the group is included in the information of the group displayed in the second window; the information of the sub-group includes identification information of the sub-group and information on the message to be processed corresponding to the sub-group.

In these alternative implementations, at least one of the plurality of groups includes a sub-group. In the group information displayed in the second window, identification information of the group and identification information of the sub-group may be included. If at least one sub-group belongs to the same first group, an identifier of the at least one sub-group belonging to the first group is displayed below the identifier of the first group.

In these alternative implementations, by displaying the information of the group and the sub-groups belonging to the group in the second window, the user can know the structure of the group, further facilitating the grouping, searching and management of the information by the user.

In some alternative implementations, the session information processing method further comprises: folding information of at least one sub-group of a group according to a folding operation performed by a user on information of the group; and displaying first prompt information in an information display area of the group in the second window; the first prompt information comprising first information for prompting that the group has a folding sub-group and second information for prompting that the folded at least one sub-group has a corresponding message to be processed.

In some application scenarios, a fold control may be provided in the information display area of the group. When the user triggers the fold control, the identifier of the at least one sub-group of the group may be folded in the second window.

In these application scenarios, simultaneous folding management of multiple sub-groups can be realized by performing a trigger operation on the fold control once, which is beneficial to improving the information processing efficiency.

In some other application scenarios, the folding operation comprises: performing a right click operation on an identifier of a sub-group of the group displayed in the second window, to trigger displaying the fold control in a display area of the sub-group; and performing a trigger operation on the fold control.

In these application scenarios, the user can fold the sub-groups one by one, enabling individual management of each sub-group.

When a group has a folded sub-group, the first prompt information may be displayed within the information display area of the group. The first prompt information here may include the above first information and the second information. The first information is used for prompting that the group has information of the folded sub-group, and the second information is used for prompting that the folded at least one sub-group has a corresponding message to be processed. As a schematic illustration, the first information is “information of further N sub-groups”, and the second information includes numbers and/or graphical or text information for indicating the numbers. The user can know from the first prompt information, whether the group has the information of the folded sub-group and whether the folded sub-group has a message to be processed. The user can know from the first prompt information whether the folded sub-group has a message to be processed. If so, by presenting the information of the folded sub-group, the purpose of browsing the message to be processed can be achieved.

In some alternative implementations, if the information of at least one sub-group of a group is in a folded state, the session information processing method further comprises:
displaying the information of the at least one sub-group according to a received display instruction for instructing displaying the information of the folded at least one sub-group.

Further, the displaying the information of the at least one sub-group, comprises: displaying the information of the at least one sub-group which was folded originally in a new window.

For example, when the display instruction for displaying the information of the folded at least one sub-group is received, a floating window or a pop-up window may be displayed, which may be displayed on an upper layer of the second window and/or the first window, and specifically, the new window may be displayed on an upper layer of a group display area to which the at least one sub-group belongs.

In these alternative implementations, since the information of the at least one sub-group that was folded originally is displayed in the new window, the information of the folded at least one sub-group may be completely displayed in the new window. In addition, integrity of the displayed information of each group can be kept in the second window.

In some alternative implementations, the session information processing method further comprises: in response to receiving an information selection operation on a target sub-group in the new window, moving information of the target sub-group to the second window, and displaying the information of the target sub-group in an information display area of the group in the second window.

In these alternative implementations, by performing a selection operation on the information of the target sub-group in the new window, the information of the target sub-group may be moved to the second window. The user may observe the information of the target sub-group within the information display area of the group.

In some alternative implementations, the displaying the information of the target sub-group in an information display area of the group in the second window, comprises: displaying the information of the target sub-group at a preset position in the information display area of the group.

The preset position here may be the bottom of the information display area of the group. If information of more than two sub-groups of the group is already displayed in the information display area of the group of the second window, after displaying the information of the target sub-group that was originally folded is triggered, the information of the target sub-group can be displayed after the originally displayed information of the more than two sub-groups.

In some alternative implementations, the displaying the information of the target sub-group in an information display area of the group in the second window, comprises: displaying the information of the target sub-group in a preset display style.

The preset display style can be display in italic, display in bold and the like.

In these alternative implementations, the information of the originally folded target sub-group is displayed after the information of other sub-groups, or the information of the target sub-group is displayed in a preset display pattern, so that the user can quickly identify the information of the originally folded target sub-group.

In some alternative implementations, the session information processing method further comprises: in response to detecting that a selection state of the information of the target sub-group is released, adjusting the information of the target sub-group from being displayed in the second window to be folded.

The selection state being released here may be triggered by: closing an interactive interface of a session or message corresponding to the target sub-group; or performing a trigger operation on a fold control displayed in the information display area of the target sub-group.

That is, the information of the target sub-group may be reset to the folded state when the selection state of the information of the target sub-group is released. This advantageously maintains an overall architecture for displaying a plurality of groups in the group information in the second window.

Please refer to FIGS. 4B to 4E, which are schematic diagrams of some application scenarios of the session information processing method. As shown in FIG. 4B, the second window 401, the first window 402, and the third window 403 may be displayed in the client interface 40 from left to right. The first window 402 in FIGS. 4B to 4E displays an information stream of the currently selected group 1, and the third window 403 displays an interactive interface of the currently selected session 2. The information displayed in the first window 401 and the third window 403 may be the same as the information displayed in FIG. 4A, which is not repeated herein.

The group information may be displayed in the second window 401. The group information may include information of group 1, group 2, group 3, and group 4. The group 2 may include 3 sub-groups. Information of the sub-groups of the group 2 may also be displayed in the second window. The displayed information of the sub-groups of the group 2 includes an identifier of the sub-group. The identifier of the sub-group may include a graphical identifier and a text identifier, e.g., graphical identifiers 45, 46, 47 of sub-group 21, sub-group 22 and sub-group 23 of the group 2 displayed in FIG. 4B. The text identifiers of the sub-groups 21, 22, 23 may be “sub-group 21”, “sub-group 22”, and “sub-group 23”, respectively. The user may perform a folding operation on the information of the sub-group. Illustratively, a right click operation may be performed for the identifier of the sub-group 23, thereby displaying an operable fold control, such as the one shown as “hide” in the text of FIG. 4B, near the display area of the sub-group 23. In response to the user performing a selection operation on the fold control, the group information of the sub-group 23 may be folded. As shown in FIG. 4C, after the information of the sub-group 23 is folded, first prompt information may be displayed in the information display area of the group 2. The first prompt information comprises first information for prompting that the group has a folding sub-group and second information for prompting that at least one folded sub-group has a corresponding message to be processed. The first information is “1 hidden sub-group” as shown in FIG. 4C. The second information is “4” displayed on the right side of the first prompt information as shown in FIG. 4C.

If a group has a folded sub-group, the first prompt information may be displayed in the group information display area. The user may issue a display instruction instructing displaying information of the folded at least one sub-group by performing a trigger operation on the first prompt information. As shown in FIG. 4D, the user may perform a click operation on the first prompt information displayed in FIG. 4C, thereby displaying the identifier of the folded sub-group 23 in a pop-up new window. The new window can be displayed on the upper layer of the second window and the first window, so that the user can browse the information of the folded sub-group 23 in the new window. The user may perform a selection operation on the sub-group 23 in the new window and, in accordance with the selection operation, the information of the sub-group 23 is moved to the second window for display. Specifically, the information of the sub-group 23 may be displayed at the end of the sub-group list of the group 2. In addition, the display style of the sub-group 23 may be different from that of other sub-groups of the group 2, such as the text identifier of the sub-group 23 displayed in italic, as shown in FIG. 4E. After the selection state of the sub-group 23 is cancelled, for example, when the user switches the selected group to another group, that is, the user no longer views the information of the sub-group, the sub-group 23 may be returned to the folded display state. That is, when the group selected by the user is another group, the information of the sub-group 23 may be hidden in the second window, referring to FIG. 4D.

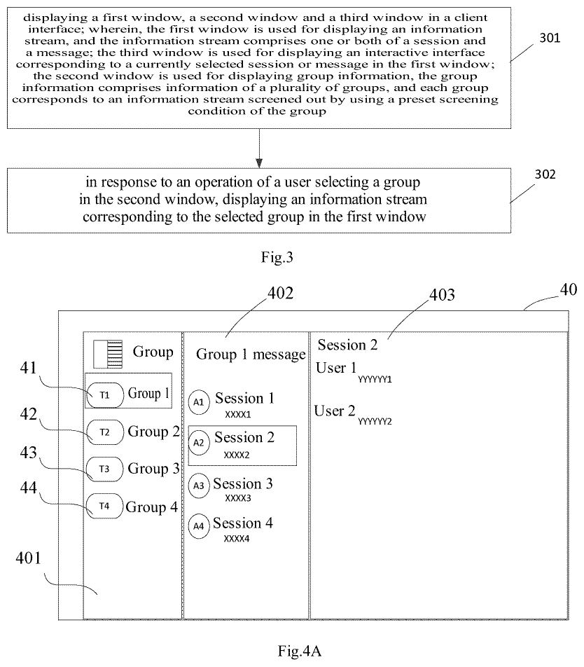

Referring to FIG. 5, a flowchart of still other embodiments of the session information processing method provided by the present disclosure is shown. As shown in FIG. 5, the session information processing method in this embodiment comprises the following steps:
step 501, displaying a first window, a second window and a third window in a client interface; wherein, the first window is used for displaying an information stream, and the information stream comprises one or both of a session and a message; the third window is used for displaying an interactive interface corresponding to a currently selected session or message in the first window; the second window is used for displaying group information, the group information comprises information of a plurality of groups, and each group corresponds to an information stream screened out by using a preset screening condition of the group;
step 502, in response to an operation of a user selecting a group in the second window, displaying an information stream corresponding to the selected group in the first window.

In this embodiment, the step 501 and the step 502 may be the same as or similar to the specific implementations of the step 301 and the step 302 in the embodiment shown in FIG. 3, and are not repeated herein.

Step 503, according to a received window width adjustment operation, determining a target display width of each window according to the adjustment operation, wherein the window width adjustment operation is used for adjusting a display width of at least one of the first window, the second window, and the third window.

Step 504, for each of the first window, the second window, and the third window, displaying display content of the window in the client interface in the display width corresponding to the window.

The adjustment operation may be an adjustment operation on any of the first window, the second window, and the third window. The adjustment operation may be a drag operation on any of the first window, the second window, and the third window. The drag operation includes an operation of increasing a window width of the window indicated by the drag operation, or an operation of decreasing the window width of the window indicated by the drag operation. For example, dragging a right border of a window to the right may increase the width of the window. If the right border of the window is dragged to the left, the width of the window is reduced. That is to say, for the left and right borders of a window, if the drag operation performed on one of the borders makes the border approach a border on the opposite side of the border, the width of the window is reduced, and the reduction is determined according to the position where the drag operation stops. If the drag operation makes the dragged border away from an opposite border of the border, the width of the window is increased, and the increase is determined according to the position where the drag operation stops.

The adjustment of the width of one window will cause a change in the width of the other windows simultaneously displayed in the client interface.

As an illustrative example, the adjustment operation is acted on a right border of the third window, and by dragging the right border to the right, the width of the third window may be increased, and at the same time, the widths of the first window and the second window shall be adjusted, to reduce the widths of the first window and the second window. The increased width of the third window may be determined according to a stop position of the drag operation, and the reduction in the widths of the first window and the second window may be determined according to the increased width of the third window.

By means of the window width adjustment operation, the width of each window is adjusted, so that the width of the window can be adjusted according to the user requirements, to provide a better information presentation effect for the user.

In some alternative implementations, the step 504 of, for each of the first window, the second window, and the third window, displaying display content of the window in the client interface in the display width corresponding to the window, comprises: for the second window, if a target width of the second window indicated by the adjustment operation is greater than or equal to a preset width threshold, displaying a graphical identifier and a text identifier of the group in the second window; and if the target width of the second window indicated by the adjustment operation is smaller than the preset width threshold, displaying the graphical identifier of the group in the second window.

The preset width threshold may be set according to a specific application scenario, and is not limited herein. As an illustrative example, the preset width threshold may be 48 pixels.

That is to say, for the second window, if the width of the second window is greater than the preset width threshold after the adjustment operation is stopped, the graphical identifier and the text identifier of the group may be displayed in the second window. If the width of the second window is smaller than the preset width threshold after the adjustment operation is stopped, the graphical identifier of the group may be displayed in the second window. In this way, the display style of the group information can be dynamically adjusted according to the change in the width of the second window.

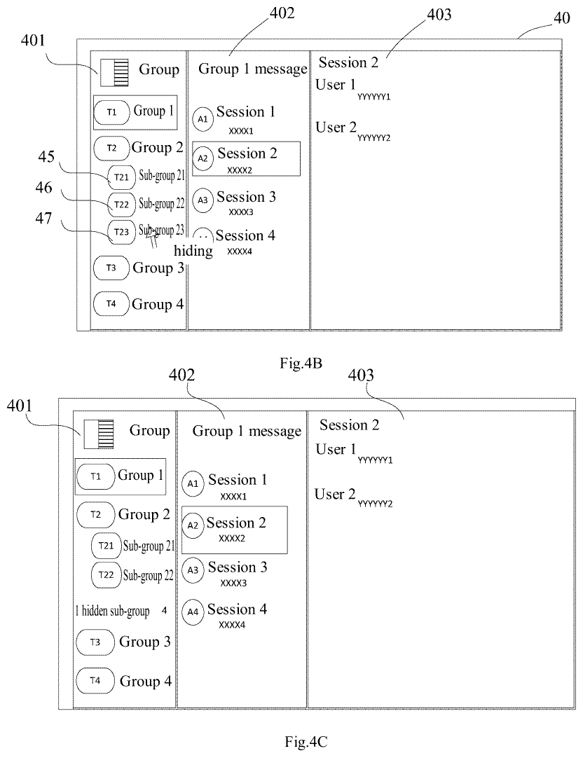

FIG. 6A to 6B are schematic diagrams illustrating an application scenario of the session information processing method of the present disclosure.

In the client interface, a second window 601, a first window 602 and a third window 603 are sequentially displayed in the client interface from left to right in the transverse direction. The second window 601 displays group information, the first window 602 displays an information stream, and the third window 603 displays an interactive interface of the selected session 2 in the first window. The information stream of the currently selected group 1 is displayed in the first window 602, and the interactive interface of the currently selected session 2 in the first window 602 is displayed in the third window 603, and detailed information may refer to the description of FIG. 4A, which is not described herein again.

The identifiers of group 1, group 2, group 3 and group 4 are displayed in the second window 601, and include graphical identifiers 61, 62, 63, 64 and text identifiers. The text identifiers of the group 1, group 2, group 3, and group 4 are: “group 1”, “group 2”, “group 3”, and “group 4”. The user may perform a window adjustment operation, where the window adjustment operation may be a drag operation on the second window, for dragging a right border of the second window 601 to the left. When the drag operation is stopped and the determined width of the second window 601 is smaller than the preset width threshold, only the graphical identifiers of the groups may be displayed in the second window 601; as shown in FIG. 6B, only the graphical identifiers 61, 62, 63, 64 respectively corresponding to the group 1, the group 2, the group 3, and the group 4 are displayed in the second window 601. The width of the first window 602 and the width of the third window 603 are adaptively adjusted as the width of the second window is adjusted. That is, the width of the first window 602 and the third window 603 increases as the width of the second window 601 decreases.

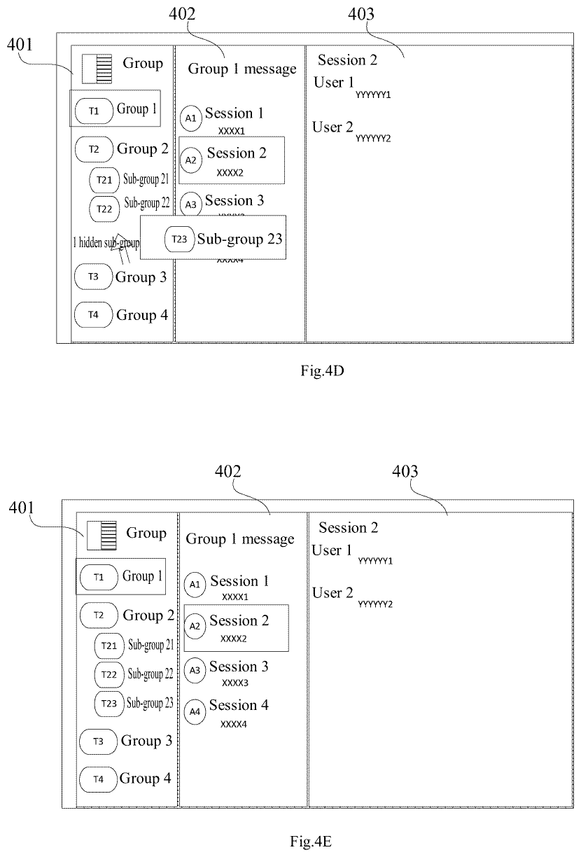

With further reference to FIG. 7, as an implementation of the method shown in the above-mentioned figures, the present disclosure provides an embodiment of a session information processing apparatus, which corresponds to the method embodiment shown in FIG. 1, and which can be specifically applied to various electronic devices.

As shown in FIG. 7, the session information processing apparatus of the present embodiment comprises: a first display unit 701 and a second display unit 702. The first display unit 701 is configured to display a first window in a client interface, the first window being used for displaying an information stream; the second display unit 702 is configured to, in response to receiving a group information display instruction, in addition to displaying the first window, display a second window in the client interface, the second window being used for displaying group information, the group information comprising information of a plurality of groups, each group corresponding to an information stream screened out by using a preset screening condition of the group, and the information stream comprising one or both of a session and a message.

In this embodiment, the detailed processing of the first display unit 701 and the second display unit 702 of the session information processing apparatus and the technical effects brought by the detailed processing can refer to the related descriptions of the step 101 and the step 102 in the corresponding embodiment of FIG. 1, and are not repeated herein.

In some alternative implementations, the client further displays a third window, the third window being used for displaying an interactive interface corresponding to a currently selected session or message in the first window; wherein, there is no overlap between the first window, the second window, and the third window; the second window, the first window and the third window are sequentially arranged in a first direction; or, the first window and the third window are not overlapped and are sequentially arranged in the first direction; the second window is displayed on the first window and/or the third window in a floating window form.

In some alternative implementations, the group information display instruction is generated based on one of: a user issuing a preset trigger operation; the preset trigger operation being used for instructing displaying the second window; a message to be processed of at least one group meeting a first preset condition; or a user performing an operation of setting a target session as a custom group through an identifier of the target session.

In some alternative implementations, the preset trigger operation comprises an operation performed on a first switching control displayed in the first window; and the second display unit 702 is further configured to: when displaying the second window, display the first switching control in the second window, and cancel displaying the first switching control in the first window.

In some alternative implementations, the second display unit 702 is further configured to: in response to receiving a group information hiding instruction, cancel displaying the second window.

In some alternative implementations, the second display unit 702 is further configured to: in response to an operation of hovering a mouse or cursor over a first switching control displayed in the first window, display the second window in a floating window form.

In some alternative implementations, the second display unit 702 is further configured to: in response to an operation of selecting a first group in the second window, display an information stream corresponding to the first group in the first window; and in response to an information stream closing instruction, cancel displaying the information stream corresponding to the first group.

In some alternative implementations, the second display unit 702 is further configured to: display an information stream corresponding to a preset default group in the first window.

In some alternative implementations, an exit control is further displayed in the first window, the information stream closing instruction being generated based on a trigger operation on the exit control.

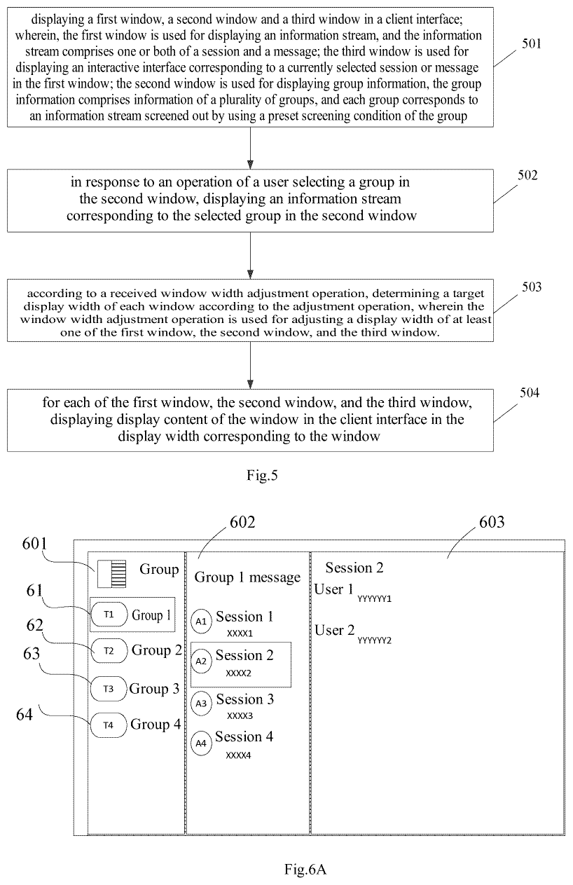

With further reference to FIG. 8, as an implementation of the method shown in the above-mentioned figures, the present disclosure provides an embodiment of a session information processing apparatus, which corresponds to the method embodiment shown in FIG. 3, and which can be specifically applied to various electronic devices.

As shown in FIG. 8, the session information processing apparatus of the present embodiment comprises: a third display unit 801 and a fourth display unit 802. The third display unit 801 is configured to display a first window, a second window, and a third window in a client interface; wherein, the first window is used for displaying an information stream, and the information stream comprises one or both of a session and a message; the third window is used for displaying an interactive interface corresponding to a currently selected session or message in the first window; the second window is used for displaying group information, the group information comprises information of a plurality of groups, and each group corresponds to an information stream screened out by using a preset screening condition of the group; the fourth display unit 802 is configured to: in response to an operation of a user selecting a group in the second window, display an information stream corresponding to the selected group in the first window.

In this embodiment, the detailed processing of the third display unit 801 and the fourth display unit 802 of the session information processing apparatus and the technical effects brought by the detailed processing may refer to relevant descriptions of the step 301 and the step 302 in the corresponding embodiment of FIG. 3, and are not repeated here.

In some alternative implementations, the second window, the first window, and the third window are sequentially arranged in a first direction in the client interface; or the first window and the third window are not overlapped and are sequentially arranged in the first direction; the second window is displayed on the first window and/or the third window in a floating window form.

In some alternative implementations, the third display unit 801 is further configured to: in response to receiving a hiding instruction for hiding the second window, cancel displaying the second window in the client interface.

In some alternative implementations, the third display unit 801 is further configured to: in a state of hiding the second window, display the first window, the second window and the third window in the client interface according to a received display instruction for instructing displaying the second window.

In some alternative implementations, the third display unit 801 is further configured to: in response to an information stream closing instruction, cancel displaying an information stream corresponding to a currently displayed group in the first window; and display an information stream corresponding to a preset default group in the first window.

In some alternative implementations, an exit control is further displayed in the first window, and the information stream closing instruction is generated based on a trigger operation on the exit control.

In some alternative implementations, a group edit control is displayed in the second window; the group edit control being used for displaying a group editing interface according to a received user selection operation, for the user to perform a group editing operation.

In some alternative implementations, the displayed group information comprises: an identifier of a group; if a group has messages to be processed, the identifier of the group and/or information on the number of the messages to be processed are highlighted.

In some alternative implementations, if a group includes at least one sub-group, information of the at least one sub-group of the group is included in the information of the group displayed in the second window; the information of the sub-group comprises identification information of the sub-group and information of the message to be processed corresponding to the sub-group.

In some alternative implementations, the third display unit 801 is further configured to: fold the information of the at least one sub-group of the group according to a folding operation performed by the user on the information of the group; and display first prompt information in an information display area of the group in the second window; the first prompt information comprising first information for prompting that the group has a folded sub-group and second information for prompting that the folded at least one sub-group has a corresponding message to be processed.

In some alternative implementations, the third display unit 801 is further configured to: if the information of at least one sub-group of a group is in a folded state, display the information of at least one sub-group according to a received display instruction for instructing displaying the information of the folded at least one sub-group.

In some alternative implementations, the third display unit 801 is further configured to: display the information of the at least one sub-group that was originally folded in a new window.

In some alternative implementations, the third display unit 801 is further configured to: in response to receiving an information selection operation on a target sub-group in the new window, move information of the target sub-group to the second window, and display the information of the target sub-group in an information display area of the group in the second window.

In some alternative implementations, the third display unit 801 is further configured to: display the information of the target sub-group at a preset position in the information display area of the group.

In some alternative implementations, the third display unit 801 is further configured to: display the information of the target sub-group in a preset display style.

In some alternative implementations, the third display unit 801 is further configured to: in response to detecting that a selection state of the information of the target sub-group is released, adjust the information of the target sub-group from being displayed in the second window to being folded.

In some alternative implementations, the third display unit 801 is further configured to: according to a received window width adjustment operation, determine a target display width of each window according to the adjustment operation, the window width adjustment operation being used for adjusting a display width of at least one of the first window, the second window and the third window; and for each window in the first window, the second window and the third window, display, in the client interface, display content of the window in the display width corresponding to the window.

In some alternative implementations, the third display unit 801 is further configured to: for the second window, if a target width of the second window indicated by the adjustment operation is greater than or equal to a preset width threshold, display a graphical identifier and text identifier of the group in the second window; and if the target width of the second window indicated by the adjustment operation is smaller than the preset width threshold, display the graphical identifier of the group in the second window.

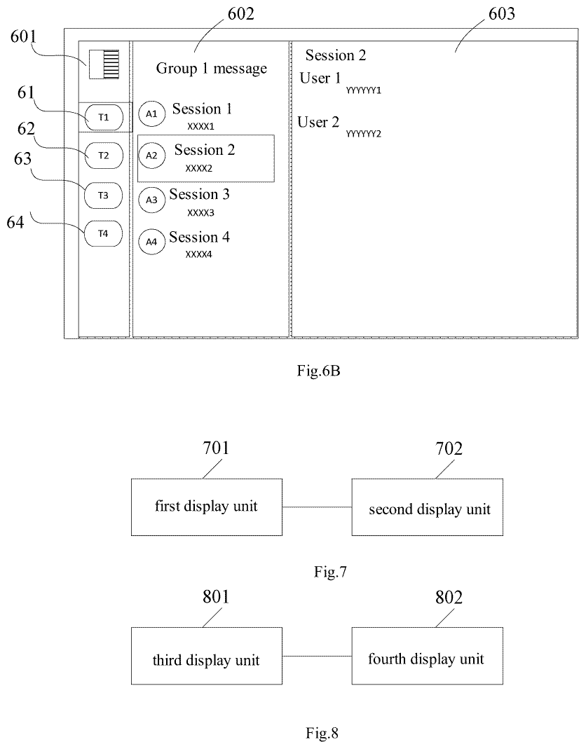

Referring to FIG. 9, FIG. 9 illustrates an exemplary system architecture to which the session information processing method of one embodiment of the present disclosure may be applied.

As shown in FIG. 9, the system architecture may include terminals 901, 902, 903, a network 904, and a server 905. The network 904 is a medium to provide communications links between the terminals 901, 902, 903 and the server 905. The network 904 may include various connection types, such as wired, wireless communication links, or fiber optic cables, among others.

The terminals 901, 902, 903 may interact with the server 905 over the network 904 to receive or transmit messages, etc. The terminals 901, 902, 903 may have various client applications installed thereon, such as a web browser application, a search type application, and a news information type application. The client application in the terminals 901, 902, 903 may receive an instruction of a user, and complete a corresponding function according to the instruction of the user, for example, display an information stream of the instant messaging application according to the instruction of the user.

The terminals 901, 902, 903 may be hardware or software. When the terminals 901, 902, 903 are hardware, they may be various electronic devices having a display screen and supporting web browsing, including but not limited to smart phones, tablet computers, e-book readers, MP3 players (Moving Picture Experts Group Audio Layer III), MP4 players (Moving Picture Experts Group Audio Layer IV), laptop portable computers, desktop computers, and the like. When the terminals 901, 902, 903 are software, they can be installed in the electronic devices listed above. They may be implemented as a plurality of software or software modules (e.g., software or software modules for providing distributed services) or as a single software or software module, which is not particularly limited herein.

The server 905 can provide various services, for example, receive information display requests sent by the terminals 901, 902, 903, analyze the information display requests, and send analysis results (for example, communication information corresponding to the display requests) to the terminals 901, 902, 903.

It should be noted that the session information processing method provided by the embodiment of the present disclosure may be performed by a terminal, and accordingly, the session information processing apparatus may be disposed in the terminals 901, 902, 903.

It should be understood that the number of terminals, networks, and servers in FIG. 9 is merely illustrative. There may be any number of terminals, networks, and servers, as desired for an implementation.

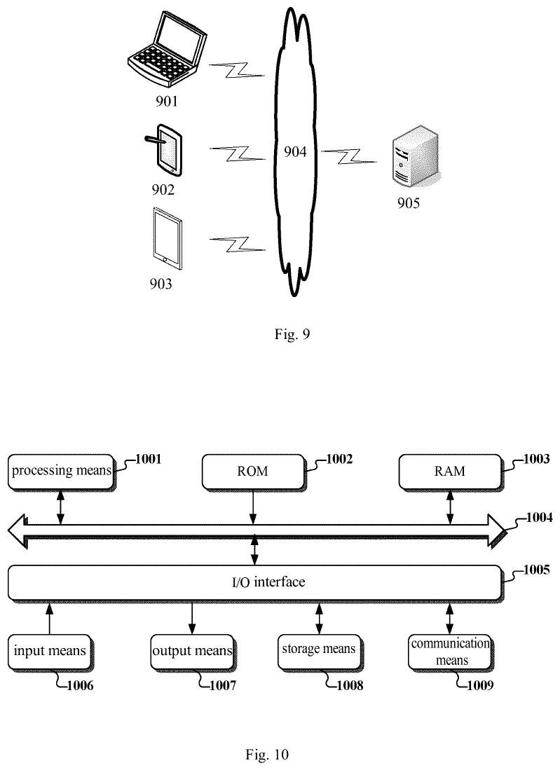

Reference is made below to FIG. 10, which shows a schematic structural diagram of an electronic device suitable for implementing the embodiments of the present disclosure. The electronic device herein refers generally to a terminal or a server (e.g., the terminal device in FIG. 9) in the form of hardware. The electronic device in the embodiments of the present disclosure may include, but is not limited to, a mobile terminal such as a mobile phone, a notebook computer, a digital broadcast receiver, a PDA (Personal Digital Assistant), a PAD (Tablet Computer), a PMP (Portable Multimedia Player), a vehicle-mounted terminal (for example, a vehicle-mounted navigation terminal), and a fixed terminal such as a digital TV, a desktop computer. The electronic device shown in FIG. 8 is only an example and should not bring any limitation to the functions and the scope of use of the embodiments of the present disclosure.

As shown in FIG. 8, the electronic device may comprise a processing means (for example, a central processing unit, a graphics processing unit, etc.) 1001 that may perform various appropriate actions and processes according to a program stored in a read-only memory (ROM) 1002 or a program loaded from a storage means 1008 into a random access memory (RAM) 1003. In the RAM 1003, various programs and data necessary for the operation of the electronic device 1000 are also stored. The processing means 1001, the ROM 1002, and the RAM 1003 are connected to each other via a bus 1004. An input/output (I/O) interface 1005 is also connected to the bus 1004.

Generally, the following means may be connected to the I/O interface 1005: an input means 1006 including, for example, a touch screen, touch pad, keyboard, mouse, camera, microphone, accelerometer, gyroscope, etc.; an output means 1007 including, for example, a liquid crystal display (LCD), speaker, vibrator, etc.; the storage means 1008 including, for example, a magnetic tape, hard disk, etc.; and a communication means 1009. The communication means 1009 may allow the electronic device to communicate wirelessly or by wire with other devices to exchange data. While the electronic device having the various means is shown in FIG. 8, it should be understood that not all illustrated means are required to be implemented or provided. More or fewer means may be alternatively implemented or provided.

In particular, according to the embodiment of the present disclosure, the processes described above with reference to the flow diagrams may be implemented as a computer software program. For example, the embodiments of the present disclosure comprise a computer program product which comprises a computer program carried on a non-transient computer-readable medium, the computer program containing program code for performing the method illustrated by the flow diagrams. In such an embodiment, the computer program may be downloaded from a network via the communications means 1009 and installed, or installed from the storage means 1008, or installed from the ROM 1002. The computer program, when executed by the processing means 1001, performs the above functions defined in the method of the embodiment of the present disclosure.

It should be noted that the above computer-readable medium of the present disclosure may be a computer-readable signal medium or a computer-readable storage medium or any combination of the above two. The computer-readable storage medium may be, for example, but is not limited to, an electronic, magnetic, optical, electromagnetic, infrared, or semiconductor system, apparatus, or device, or any combination of the foregoing. More specific examples of the computer-readable storage medium may comprise, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium that can contain or store a program which can be used by or in conjunction with an instruction execution system, apparatus, or device. However, in the present disclosure, the computer-readable signal medium may comprise a data signal propagated in baseband or as part of a carrier wave, in which computer-readable program code is carried. Such a propagated data signal may take a variety of forms, including, but not limited to, an electromagnetic signal, optical signal, or any suitable combination of the forgoing. The computer-readable signal medium may also be any computer-readable medium other than the computer-readable storage medium, wherein the computer-readable signal medium can send, propagate, or transmit a program for use by or in conjunction with an instruction execution system, apparatus, or device. The program code contained on the computer-readable medium may be transmitted using any appropriate medium, including but not limited to: a wire, an optical cable, RF (Radio Frequency), etc., or any suitable combination of the foregoing.

In some embodiments, a client and a server may communicate using any currently known or future developed network protocol, such as HTTP (HyperText Transfer Protocol), and may be interconnected with any form or medium of digital data communication (e.g., a communication network). Examples of the communication network include a local area network (“LAN”), a wide area network (“WAN”), an internet (e.g., the Internet), and a peer-to-peer network (e.g., an ad hoc peer-to-peer network), as well as any currently known or future developed network.

The above computer-readable medium may be embodied in the above electronic device; or may be exist separately without being assembled into the electronic device.

The above computer-readable medium has one or more programs carried thereon, wherein the above one or more programs, when executed by the electronic device, cause the electronic device to:
display a first window in a client interface, the first window being used for displaying an information stream; and in response to receiving a group information display instruction, in addition to displaying the first window, display a second window in the client interface, the second window being used for displaying group information, the group information comprising information of a plurality of groups, each group corresponding to an information stream screened out by using a preset screening condition of the group, the information stream comprising one or both of a session and a message; or, display a first window, a second window and a third window in a client interface; wherein, the first window is used for displaying an information stream, and the information stream comprises one or both of a session and a message; the third window is used for displaying an interactive interface corresponding to a currently selected session or message in the first window; the second window is used for displaying group information, the group information comprises information of a plurality of groups, and each group corresponds to an information stream screened out by using a preset screening condition of the group; and in response to an operation of a user selecting a group in the second window, display an information stream corresponding to the selected group in the first window.

The computer program code for performing the operations of the present disclosure may be written in one or more programming languages or a combination thereof, wherein the above programming language includes but is not limited to an object-oriented programming language such as Java, Smalltalk, C++, and includes a conventional procedural programming language, such as the “C” language or similar programming languages. The program code may be executed entirely on a user's computer, partly on a user's computer, as a stand-alone software package, partly on a user's computer and partly on a remote computer, or entirely on a remote computer or server. In a scenario where the remote computer is involved, the remote computer may be connected to the user's computer through any type of network, including a local area network (LAN) or a wide area network (WAN), or may be connected to an external computer (for example, through the Internet using an Internet service provider).

The flow diagrams and block diagrams in the drawings illustrate the possibly implemented architecture, functions, and operations of the system, method and computer program product according to various embodiments of the present disclosure. In this regard, each block in the flow diagrams or block diagrams may represent a module, program segment, or portion of code, which comprises one or more executable instructions for implementing a specified logical function. It should also be noted that, in some alternative implementations, functions noted in blocks may occur in an order different from that noted in the drawings. For example, two blocks shown in succession may, in fact, be executed substantially concurrently, or they may sometimes be executed in a reverse order, which depends upon the functions involved. It will also be noted that each block in the block diagrams and/or flow diagrams, and a combination of blocks in the block diagrams and/or flow diagrams, can be implemented by a special-purpose hardware-based system that performs specified functions or operations, or by a combination of special-purpose hardware and computer instructions.

The unit involved in the embodiments of the present disclosure may be implemented by software or hardware. The name of the unit does not, in some cases, constitute a limitation on the unit itself.

The functions described above herein may be executed, at least partially, by one or more hardware logic components. For example, without limitation, exemplary types of the hardware logic component that may be used include: a field programmable gate array (FPGA), application specific integrated circuit (ASIC), application specific standard product (ASSP), system on chip (SOC), complex programmable logic device (CPLD), and the like.

In the context of this disclosure, a machine-readable medium may be a tangible medium, which can contain or store a program for use by or in conjunction with an instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combination of the foregoing. More specific examples of the machine-readable storage medium include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

The foregoing only describes the preferred embodiments of the present disclosure and the technical principles employed. It should be appreciated by those skilled in the art that the disclosed scope involved in the present disclosure is not limited to the technical solutions formed by specific combinations of the technical features described above, but also encompasses other technical solutions formed by arbitrary combinations of the above technical features or equivalent features thereof without departing from the above disclosed concepts, for example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing might be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

The foregoing only describes the preferred embodiments of the present disclosure and the technical principles employed. It should be appreciated by those skilled in the art that the disclosed scope involved in the present disclosure is not limited to the technical solutions formed by specific combinations of the technical features described above, but also encompasses other technical solutions formed by arbitrary combinations of the above technical features or equivalent features thereof without departing from the above disclosed concepts, for example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing might be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination. Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

1. A session information processing method, comprising:
displaying a first window in a client interface, the first window being used for displaying an information stream; and
in response to receiving a group information display instruction, in addition to displaying the first window, displaying a second window in the client interface, the second window being used for displaying group information, the group information comprising information of a plurality of groups, each group corresponding to an information stream screened out by using a preset screening condition of the group, the information stream comprising one or both of a session and a message.

2. The method according to claim 1, wherein, the client further displays a third window, the third window being used for displaying an interactive interface corresponding to a currently selected session or message in the first window; wherein,
there is no overlap between the first window, the second window, and the third window; the second window, the first window and the third window are sequentially arranged in a first direction;
or,
the first window and the third window are not overlapped and are sequentially arranged in the first direction;
the second window is displayed on at least one of the first window or the third window in a floating window form,
or, wherein the group information display instruction is generated based on one of:
a user issuing a preset trigger operation; the preset trigger operation being used for instructing displaying the second window:
a message to be processed of at least one group meeting a first preset condition; or
a user performing an operation of setting a target session as a custom group through an identifier of the target session.

3. (canceled)

4. The method according to claim 2, wherein, the preset trigger operation comprises an operation performed on a first switching control displayed in the first window; and
when displaying the second window, displaying the first switching control in the second window, and canceling displaying the first switching control in the first window.

5. The method according to claim 1, wherein, the method further comprises: in response to receiving a group information hiding instruction, cancelling displaying the second window,
or, the in response to receiving a group information display instruction, in addition to displaying the first window, displaying a second window in the client interface, comprises:
in response to an operation of hovering a mouse or cursor over a first switching control displayed in the first window, displaying the second window in a floating window form,
or, wherein the method further comprises:
in response to an operation of selecting a first group in the second window, displaying an information stream corresponding to the first group in the first window; and
in response to an information stream closing instruction, cancelling displaying the information stream corresponding to the first group.

6-7. (canceled)

8. The method according to claim 5, wherein, after the cancelling displaying the information stream corresponding to the first group, the method further comprises:
displaying an information stream corresponding to a preset default group in the first window,
or, wherein an exit control is further displayed in the first window, the information stream closing instruction being generated based on a trigger operation on the exit control.

9. (canceled)

10. A session information processing method, comprising:
displaying a first window, a second window and a third window in a client interface;
wherein, the first window is used for displaying an information stream, and the information stream comprises one or both of a session and a message; the third window is used for displaying an interactive interface corresponding to a currently selected session or message in the first window; the second window is used for displaying group information, the group information comprises information of a plurality of groups, and each group corresponds to an information stream screened out by using a preset screening condition of the group; and
in response to an operation of a user selecting a group in the second window, displaying an information stream corresponding to the selected group in the first window.

11. The method according to claim 10, wherein
the second window, the first window, and the third window are sequentially arranged in a first direction in the client interface;
or,
the first window and the third window are not overlapped and are sequentially arranged in the first direction; the second window is displayed on at least one of the first window or the third window in a floating window form,
or wherein, the method further comprises:
in response to receiving a hiding instruction for hiding the second window, cancelling displaying the second window in the client interface.

12. (canceled)

13. The method according to claim 10, wherein, the method further comprises:
in a state of hiding the second window, displaying the first window, the second window and the third window in the client interface according to a received display instruction for instructing displaying the second window.

14. The method according to claim 10, wherein, the method further comprises:
in response to an information stream closing instruction, cancelling displaying an information stream corresponding to a currently displayed group in the first window; and displaying an information stream corresponding to a preset default group in the first window.

15. The method according to claim 14, wherein, an exit control is further displayed in the first window, and the information stream closing instruction is generated based on a trigger operation on the exit control.

16. The method according to claim 10, wherein, the displayed group information comprises:
an identifier of a group;
if a group has messages to be processed, at least one of the identifier of the group or information on the number of the messages to be processed are highlighted,
or wherein, if a group includes at least one sub-group, information of the at least one sub-group of the group is included in the information of the group displayed in the second window;
the information of the sub-group comprises identification information of the sub-group and information of the message to be processed corresponding to the sub-group.

17. (canceled)

18. The method according to claim 16, wherein, the method further comprises:
folding the information of the at least one sub-group of the group according to a folding operation performed by the user on the information of the group; and
displaying first prompt information in an information display area of the group in the second window; the first prompt information comprising first information for prompting that the group has a folded sub-group and second information for prompting that the folded at least one sub-group has a corresponding message to be processed,
or, wherein, if information of at least one sub-group of a group is in a folded state, the method further comprises:
displaying the information of the folded at least one sub-group according to a received display instruction for instructing displaying the information of the folded at least one sub-group.

19. (canceled)

20. The method according to claim 18, wherein, the displaying the information of the folded at least one sub-group, comprises: displaying the information of the at least one sub-group that was originally folded in a new window; and the method further comprises:
in response to receiving an information selection operation on a target sub-group in the new window, moving information of the target sub-group to the second window, and displaying the information of the target sub-group in an information display area of the group in the second window.

21. The method according to claim 20, wherein, the displaying the information of the target sub-group in an information display area of the group in the second window, comprises:
highlighting the information of the target sub-group in the information display area of the group,
or, wherein, the method further comprises:
in response to detecting that a selection state of the information of the target sub-group is released, adjusting the information of the target sub-group from being displayed in the second window to being folded.

22. (canceled)

23. The method according to claim 10, wherein, the method further comprises:
according to a received window width adjustment operation, determining a target display width of each window according to the adjustment operation, the window width adjustment operation being used for adjusting a display width of at least one of the first window, the second window and the third window; and
for each window in the first window, the second window and the third window, displaying, in the client interface, display content of the window in the display width corresponding to the window. Preliminary Amendment: First Action Not Yet Received

24. The method according to claim 23, wherein, the for each window in the first window, the second window and the third window, displaying, in the client interface, display content of the window in the display width corresponding to the window, comprises:
for the second window, if a target width of the second window indicated by the adjustment operation is greater than or equal to a preset width threshold, displaying a graphical identifier and text identifier of the group in the second window; and
if the target width of the second window indicated by the adjustment operation is smaller than the preset width threshold, displaying the graphical identifier of the group in the second window.

25-26. (canceled)

27. An electronic device, comprising:
one or more processors; and
storage means configured to store one or more programs, which when executed by the one or more processors, cause the one or more processors to implement a session information processing method, comprising:
displaying a first window in a client interface, the first window being used for displaying an information stream; and
in response to receiving a group information display instruction, in addition to displaying the first window, displaying a second window in the client interface, the second window being used for displaying group information, the group information comprising information of a plurality of groups, each group corresponding to an information stream screened out by using a preset screening condition of the group, the information stream comprising one or both of a session and a message.

28. A non-transitory computer readable medium having thereon stored a computer program, which when executed by a processor, implements the method according to claim 1.

29. A non-transitory computer readable medium having thereon stored a computer program, which when executed by a processor, implements the method according to claim 10.

30. An electronic device, comprising:
one or more processors; and
storage means configured to store one or more programs, which when executed by the one or more processors, cause the one or more processors to implement the method according to claim 10.
